(19) United States
(12) Patent Application Publication
(10) Pub. No.: US 2014/0287347 A1
(43) Pub. Date: Sep. 25, 2014

(54) METHOD FOR FABRICATING A MEMBRANE-ELECTRODE ASSEMBLY

(71) Applicant: Commissariat A L'Energie Atomique Et Aux Energies Alternatives, Paris (FR)

(72) Inventors: Remi Vincent, Grenoble (FR); Eric Mayousse, Grenoble (FR); Denis Tremblay, Pommiers-La-Placette (FR)

(21) Appl. No.: 14/221,483

(22) Filed: Mar. 21, 2014

(30) Foreign Application Priority Data
Mar. 22, 2013 (FR) 1352579

(51) Int. Cl. H01M 8/10

(52) U.S. Cl. CPC H01M 8/1004
USPC 429/535

(57) ABSTRACT

A method for fabricating a membrane-electrode assembly having a proton-exchange membrane includes supplying a proton-exchange membrane, depositing cathodic electrocatalytic ink on a first face of a first gas diffusion layer, assembling the proton-exchange membrane with the first gas diffusion layer, including securing the first face of the first gas diffusion layer with a first face of the proton-exchange membrane, depositing anodic electrocatalytic ink on a second face of the proton-exchange membrane, the second face being opposite the first face, and assembling the second gas diffusion layer with the membrane, including securing a second face thereof with a first face of the second gas diffusion layer.

### RELATED APPLICATIONS

Under 35 USC 119, this application claims the benefit of the Mar. 22, 2013 priority date of French application 1352579, the contents of which are herein incorporated by reference.

### FIELD OF INVENTION

The invention relates to the production of gas by electrolysis, and in particular, to devices for producing hydrogen that use a proton-exchange membrane to implement a low-temperature electrolysis of water.

### BACKGROUND

Fuel cells are envisaged as an electrical supply system for motor vehicles produced on a large scale in the future, and for a large number of applications. A fuel cell is an electrochemical device that converts chemical energy directly into electrical energy.

Dihydrogen is often used as the fuel of the fuel cell. Dihydrogen is oxidized on an electrode of the cell and dioxygen of the air is reduced on another electrode of the cell. The chemical reaction produces water. The great advantage of the fuel cell is the avoidance of discharges of atmospheric polluting compounds at the place of electricity generation.

One of the major difficulties in developing such fuel cells lies in the synthesis and procurement of dihydrogen. On land, hydrogen exists in large quantities only in combination with oxygen (in the form of water), with sulphur (hydrogen sulphide), with nitrogen (ammonia) or with carbon (fossil fuels of natural gas or oil types). The production of dihydrogen therefore entails either consuming fossil fuels, or having significant quantities of low-cost energy, to obtain it from the breakdown of water, by thermal or electrochemical means.

The most widely used method of producing dihydrogen from water thus consists in using the principle of electrolysis.

It is known to use an electrolyzer produced with a proton-exchange membrane (PEM) to produce dihydrogen from water via electrolysis. In such an electrolyzer, an anode and a cathode are fastened on either side of the proton-exchange membrane and placed in contact with water. A potential difference is applied between the anode and the cathode. Thus, oxygen is produced at the anode by oxidation of the water. The oxidation at the anode also generates H+ ions. These ions pass through the proton-exchange membrane to the cathode. Electrons are returned to the cathode by the electrical supply. At the cathode, the H+ ions are reduced to generate dihydrogen.

The potential of the standard hydrogen electrode (SHE) (at 100 kPa and 298.15 K) of the H+/H2 pair is equal to 0V. The standard potential SHE of the O2/H2O pair is equal to 1.23 V SHE. In this description, the potentials are expressed in relation to the potential of the standard hydrogen electrode and are denoted “V SHE”. The anodic materials must therefore withstand high potentials (typically >1.5 V SHE). Noble materials, such as platinum on the cathode or iridium on the anode, are more often than not used for this.

The performance levels of the foregoing electrolyzers exhibit limitations that are partly linked to the method for fabricating the membrane-electrode assembly.

Among the known fabrication methods, a distinction is drawn between a first category of methods, which is based on the deposition and drying of electrocatalytic inks directly on the membrane, and a second category of methods, which is based on deposition and drying of ink on the material of a current distributor placed facing an electrode.

The production of membrane/electrode assemblies (AME) by the deposition of two electrocatalytic layers on two opposite faces of a membrane can be implemented according to a number of different variants.

According to a first variant, the anodic and cathodic inks are deposited independently on external supports. These depositions are then transferred to the membrane during a hot pressing. This variant offers the advantage of being able to control the loadings of catalyst in the electrodes. On the other hand, the transfer is sometimes difficult, particularly when the two depositions are transferred simultaneously. A simultaneous transfer of the two depositions avoids conducting two hot pressings, which could create thermal and mechanical stresses likely to embrittle the membrane in its future use. This variant does, however, present a relatively high level of irreversible waste. In practice, even if just one of the two transfers is spoiled, both electrodes and the membrane are scrapped.

[According to a second variant, for example that described in the patent application WO 2012/044273 A1 (UTC POWER CORPORATION), electrocatalytic ink is deposited directly on the proton-exchange membrane. This deposition initially brings about an inflation of the membrane, a retraction then occurring on drying, with relatively significant amplitudes because the membrane has little support. These deformations generate mechanical stresses in the depositions that can induce hairline cracks in the electrodes. The direct consequence of such hairline cracks is a reduction of the electronic perculation of the electrode and therefore the reduction of its electrical conductivity. Furthermore, the hairline cracks can affect the electrode/membrane cohesion.

In operation, the membrane is totally immersed in water. This immersion makes its inflation rate maximal, which accentuates the mechanical stresses present at the electrode-membrane interface. This de-structuring of the AME reduces the energy efficiency of the electrolyzer and its lifespan.

Another problem linked to this variant stems from the damage done to the membrane by the solvents present the electrocatalytic ink, for example ethanol, isopropanol etc. This damage increases the permeability of the membrane, which reduces the lifespan of the electrolyzer. In addition, the gases produced by the electrolyzer are then less pure. This can prove detrimental to the use of the electrolyzer.

Moreover, after having deposited a first electrode on the membrane, this membrane is no longer perfectly flat to proceed with the deposition of the second electrode. The problems of stresses and heterogeneities cited previously are then amplified for the second electrode.

The method that consists of depositing electrocatalytic ink on the current distributor presents a few drawbacks, mainly on the anode.

In practice, the overvoltages needed for the electrooxidation of the water are high. Thus, the anodic potential of the PEM electrolysers is generally very high (>1.6 V SHE) making it impossible to use carbonaceous materials and, in particular, diffusion layers of carbon (felt, papers, fabrics) that are conventionally used on the cathodic side or in a fuel cell with a proton-exchange membrane. The current distributors used as the anode are therefore generally sintered porous titanium or titanium gratings. The direct deposition of the electrocatalytic layer has the major defect of clogging the distributor, thus limiting the transport of water to the catalyst. Furthermore, when the electrocatalytic layer is deposited on the distributor, a proportion of the catalyst is lodged inside the pores of the distributor and does not participate in operation. Also, the electrode/membrane interface is overall unsatisfactory. These drawbacks are reflected in a notable limiting of the performance levels of the electrolyzer.

Furthermore, the deposition on the distributor renders the electrolyzer difficult to recycle because the separation of the noble metals present in the interstices of the current distributor becomes more difficult. Furthermore, the distributors that are commonly used such as sintered porous titanium require costly machining, which economically limits the possibility of using a sintered material for each membrane/electrode assembly.

### SUMMARY

The invention aims to resolve one or more of these drawbacks. The invention thus relates to a method for fabricating a membrane-electrode assembly with a proton-exchange membrane.

### BRIEF DESCRIPTION OF THE DRAWINGS

In one aspect, the invention features a method for fabricating a membrane-electrode assembly having a proton-exchange membrane. Such a method includes supplying a proton-exchange membrane, depositing cathodic electrocatalytic ink on a first face of a first gas diffusion layer, assembling the proton-exchange membrane with the first gas diffusion layer, including securing the first face of the first gas diffusion layer with a first face of the proton-exchange membrane, depositing anodic electrocatalytic ink on a second face of the proton-exchange membrane, the second face being opposite the first face, and assembling the second gas diffusion layer with the membrane, including securing a second face thereof with a first face of the second gas diffusion layer.

In some practices, the deposited anodic electrocatalytic ink includes a mixture of a catalyst in suspension in an aqueous solvent, and a binder including a polymer in suspension in an organic solvent.

Among these practices of the invention are those in which the anodic electrocatalytic ink comprises alcohol with a concentration by weight less than 5%, those in which the catalyst of the anodic electrocatalytic ink includes iridium oxide, those in which a dry extract of the anodic electrocatalytic ink exhibits a concentration by weight of catalyst less than 10%, those in which the binder of the anodic electrocatalytic ink includes an ionomer, and those in which a ratio of concentrations by weight of dry extract of the binder and of the catalyst of the anodic electrocatalytic ink is less than or equal to 30%.

In some practices of the invention, the cathodic electrocatalytic ink includes a carbonaceous material. In others, it includes platinum.

Also among the practices of the invention are those in which assembling the membrane with the first gas diffusion electrode includes hot pressing. Among these are those in which hot pressing includes hot pressing at a temperature of greater than or equal to 120° C., with a pressure greater than or equal to 1 MPa, for a duration greater than three minutes.

In some practices, the supplied first and second gas diffusion layers each have a rigidity of between two and forty units on the Taber rigidity scale.

In others, securing the first gas diffusion layer includes causing adhesion of the deposited cathodic electrocatalytic ink with the first face of the proton-exchange membrane.

In yet others, securing the second gas diffusion layer includes causing adhesion of the deposited anodic electrocatalytic ink with the first face of the second gas diffusion layer.

Other features and advantages of the invention will clearly emerge from the following description, given as an indication and non-limiting example, with reference to the appended drawings, in which:

FIG. 1 is a schematic cross-section view of an exemplary electrolysis device incorporating a membrane-electrode assembly;

FIG. 2 is a flow diagram of a method for fabricating the membrane/electrode assembly of FIG. 1;

FIGS. 3 to 7 illustrate the fabrication of the membrane-electrode assembly of FIG. 1 during different steps of the method of FIG. 2.

### DETAILED DESCRIPTION

The invention proposes a method for fabricating a membrane-electrode assembly with a proton-exchange membrane. The creation of the cathode on a gas diffusion layer and the assembly of this gas diffusion layer with a proton-exchange membrane, prior to the creation of the anode, reduces the risk of damage to this proton-exchange membrane during the creation of the anode.

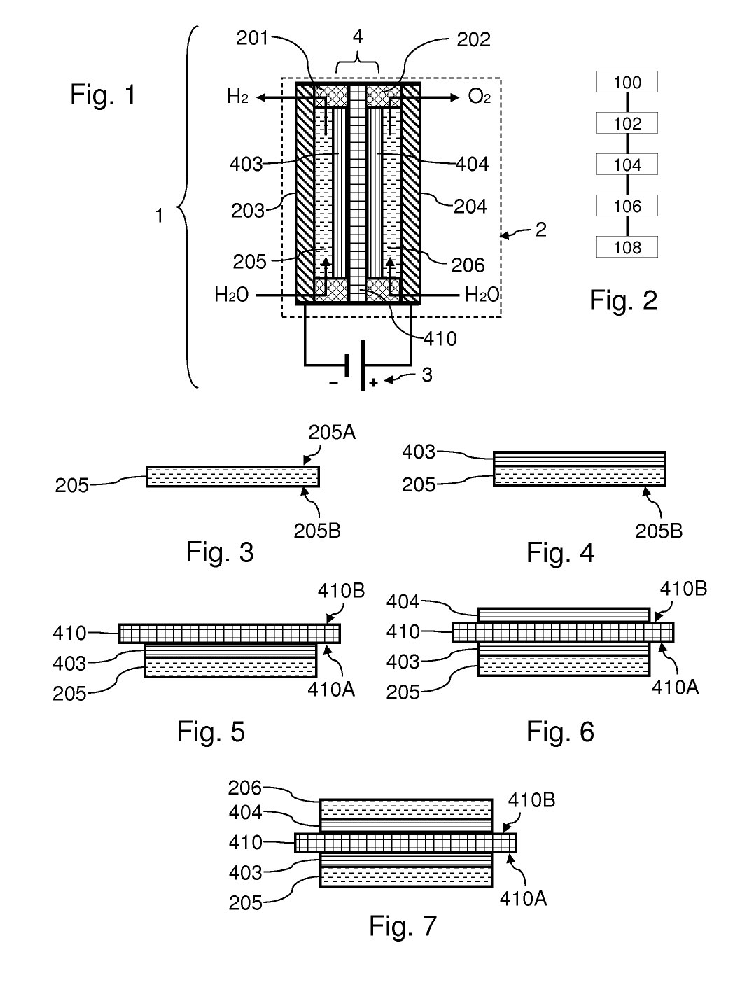

FIG. 1 represents an electrolysis device 1. The electrolysis device 1 is suitable for producing dihydrogen (H₂) by the electrolysis of water (H₂O) when an electrical potential difference is applied between an anode and a cathode of this electrolysis device 1. The production of dihydrogen by electrolysis of the water comprises the simultaneous performance of the following chemical reactions: 2H₂O→4H++4e−+O₂ and 2H++2e—→H₂.

To this end, the electrolysis device 1 comprises an electrochemical cell 2 and an electrical power supply 3.

The electrochemical cell 2 comprises: a membrane electrode assembly (AME) 4, two seals 201 and 202, two electrical supply plates 203 and 204 made of an electrically conductive material, and two gas diffusion layers (also called “porous current distributors”) 205 and 206.

The assembly 4 comprises a proton-exchange membrane 410, as well as a cathode 403 and an anode 404.

The function of the membrane 410 is to be passed through by protons originating from the anode 404 to the cathode 403 during the electrolysis of the water, while blocking the electrons and the dioxygen (O₂) and the dihydrogen generated by the electrolysis of the water. The permeability of the proton-exchange membrane to dihydrogen is greater than its permeability to dioxygen. In this example, the membrane 410 is a layer of a fluorinated polymer material, such as the material distributed under the marketing reference “NAFION” by the company DuPont. The membrane 410 is here of planar form.

The cathode 403 and the anode 404 are fastened on either side of this membrane 410 on opposite faces thereof. The cathode 403 is fixed onto a first face of the membrane 410. The anode 404 is fixed onto a second face of the membrane 410 opposite the first face. Each of the cathode 403 and the anode 404 comprises a catalyst material configured to favor the chemical reactions of electrolysis. This catalyst material is typically a noble metal. For example, the catalyst material of the cathode 403 is platinum.

In this description, the cathode 403 and the anode 404 are produced by the deposition of a layer of electrocatalytic ink. In this description, “cathodic electrocatalytic ink” will be used to designate the layer of ink forming the cathode 403, and “anodic electrocatalytic ink” will be used to designate the layer of ink forming the anode 404. The method for creating this cathode 403 and this anode 404 will be described in more detail below, with reference in particular to FIG. 2.

In this example, the anodic electrocatalytic ink includes, before deposition, a mixture a catalyst, in suspension in an aqueous solvent; and a binder, comprising a polymer, such as an ionomer, in suspension in an organic solvent, such as alcohol.

The dry extract of this ink here exhibits a concentration by weight of catalyst less than 10% or less than 8%, or less than 5%. In one example, the catalyst is iridium oxide.

The ratio of the concentrations by weight of dry extract of the binder in relation to the catalyst in this mixture is advantageously less than or equal to 30%, less than or equal to 20%, or less than or equal to 15%. Preferably, it is equal to 10%. This ratio of the concentrations by weight is advantageously greater than or equal to 3%.

The total concentration by weight of alcohol in this mixture is advantageously less than 10%, less than 5%, or less than 3%.

The plate 203 provides a water supply conduit, in communication with the cathode 403 via the layer 205. The plate 203 also provides a dihydrogen evacuation conduit, in communication with the cathode 403 via the layer 205.

The plate 204 provides a water supply conduit in communication with the anode 404 via the layer 206. The plate 204 also provides a dioxygen evacuation conduit in communication with the anode 404 via the layer 206. To simplify FIG. 1, these conduits are not represented in detail.

The function of the gas diffusion layers 205 and 206 is to allow for the circulation: of the water, of the dihydrogen and of the dioxygen between the assembly 4 and the respective supply conduits of the plates 203 and 204, and of charge carriers between the assembly 4 and the circuit 3.

To this end, the layer 205 is interposed between the cathode 403 and the plate 203. The layer 206 is interposed between the anode 404 and the plate 204.

The layer 205 is, for example, a porous carbonaceous support forming a gas diffusion layer (for example carbonaceous felt, paper or fabric). The illustrated layer 206 comprises a material suitable for supporting a high electrical potential (for example greater than or equal to 1.6 V SHE) which is typically present at the anode 404 during the electrolysis reaction. The illustrated layer 206 comprises a layer formed by the sintering of porous titanium, or a grating made of titanium. These layers 205 and 206 each exhibit a rigidity of between 2 and 40 units on the Taber rigidity scale, as defined by the company “Taber industries.” Advantageously, this rigidity is between 10 and 30 Taber rigidity units. It is considered here that 10 Taber units corresponds to a rigidity of 0.981 mN·m.

The electrical power supply 3 is configured to apply a DC voltage between the plates 203 and 204. This voltage is chosen such that the current density circulating in the plates 203 and 204 is between 10 and 40,000 A/m², and advantageously between 500 and 40,000 A/m². This voltage is between 1.3 V and 3.0 V. Through the application of such a voltage, a water oxidation reaction on the anode 404 produces dioxygen and, simultaneously, a proton reduction reaction on the cathode 403 produces dihydrogen. The reaction at the anode 404 is as follows: 2H₂O−4H++4e−+O₂.

The protons (H+) generated by this reaction pass through the proton-exchange membrane 410 to the cathode 403. The power supply 3 conducts the electrons generated by the anodic reaction to the cathode 403. The reaction on the cathode 403 is thus as follows: 2H++2e−→H₂.

An example of a method for fabricating the assembly 4 will now be described, with reference to the flow diagram of FIG. 2 and with the aid of FIGS. 3 to 6.

In step 100, the diffusion layer 205 is supplied, as illustrated by FIG. 3. This layer 205 has an essentially planar form and has two opposing faces 205A and 205B.

Then, in step 102, the cathode 403 is formed on a face of this layer 205, as illustrated by FIG. 4. The cathode 403 is formed by the deposition of a layer of electrocatalytic ink on the face 205A, by carrying out a wet deposition technique, then by the drying of this electrocatalytic ink. On completion of this step, the cathode 403 is securely attached, with no degree of freedom, to the face 205A.

Then, in step 104, the membrane 410 is assembled with the layer 205, as illustrated by FIG. 5. The membrane 410 has two main faces 410A, 410B. This assembly operation entails bringing the cathode 403 deposited on the face 205A into contact with a face 410A of the membrane 410. This assembly is here performed by means of a hot pressing operation. During this hot pressing operation, these two faces are brought into direct contact with one another, raised to a temperature greater than or equal to 120° C. or 130° C. or 135° C., and held in contact by the application of a mechanical pressure exerted at right angles to the faces 205A and 410A. In particular embodiments, the pressure is greater than or equal to 1 MPa or 1.5 MPa or 2 MPa. In preferred embodiments, the pressure is equal to 3.5 MPa. This hot pressing operation for example has a duration longer than 3 minutes, longer than 4 minutes, or longer than 5 minutes.

On completion of this step, the membrane 410 is securely attached, with no degree of freedom to the layer 205 through the adhesion between the cathode 403 and the face 410A. Because of the rigidity of the layer 205, the risk of inflation of the membrane 410 or of the appearance of mechanical stresses in this membrane 410 is reduced, particularly in the subsequent steps of production of the anode 404.

Then, in step 106, the anode 404 is formed on the face 410B of the membrane 410, as illustrated by FIG. 6. In this example, the anode 404 is formed by the deposition of a layer of anodic electrocatalytic ink on the face 410B by wet deposition followed by drying. On completion of this step, the anode 404 is securely attached, with no degree of freedom, to the membrane 410.

Finally, in step 108, illustrated by FIG. 7, the layer 206 is assembled with the membrane 410. This assembly operation entails bringing the anode 404 deposited on the face 410B into contact with a face of the layer 206, for the layer 206 to be securely attached, with no degree of freedom, with the membrane 410, through adhesion between the anode 404 and the face 410B. In some examples, this assembly includes a hot pressing operation performed using the same force, at the same temperature, and for the same duration parameters as those described for the hot pressing operation of the step 104. Advantageously, in subsequent steps, the seals 201 and 202 are added to form the cell 2.

Numerous other embodiments are possible.

The assembly 4 fabricated in this way can be used in a device other than the electrolysis device 1. For example, the assembly can be used in a fuel cell.

The composition of the cathodic and anodic electrocatalytic inks forming, respectively, the cathode 403 and the anode 404, can be different. Notably, the catalyst material of each of these inks can be different. For example, in one embodiment, the catalyst of the anodic electrocatalytic ink includes an alloy of indium and iridium.

In another embodiment, the binder of the anodic electrocatalytic ink is an ionomer such as the material distributed under the marketing name “AQUIVION” by the company “Solvay”, or else the material distributed under the name “FUMION” distributed by the company “Fuma Tech GmbH.”

The parameters of the hot pressing operation can be chosen differently.

Having described the invention, and a preferred embodiment thereof, what is claimed as new, and secured by Letters Patent is:

1. A method for fabricating a membrane-electrode assembly having a proton-exchange membrane, said method comprising supplying a proton-exchange membrane, depositing cathodic electrocatalytic ink on a first face of a first gas diffusion layer, assembling said proton-exchange membrane with said first gas diffusion layer, including securing said first face of said first gas diffusion layer with a first face of said proton-exchange membrane, depositing anodic electrocatalytic ink on a second face of said proton-exchange membrane, said second face being opposite said first face, and assembling said second gas diffusion layer with said membrane, including securing a second face thereof with a first face of said second gas diffusion layer.

2. The method of claim 1, further comprising choosing said deposited anodic electrocatalytic ink to include a mixture of a catalyst in suspension in an aqueous solvent, and a binder comprising a polymer in suspension in an organic solvent.

3. The method of claim 2, further comprising choosing said anodic electrocatalytic ink to comprise alcohol with a concentration by weight less than 5%.

4. The method of claim 2, further comprising choosing said catalyst of said anodic electrocatalytic ink to include iridium oxide.

5. The method of claim 2, wherein a dry extract of said anodic electrocatalytic ink exhibits a concentration by weight of catalyst less than 10%.

6. The method of claim 2, wherein said binder of said anodic electrocatalytic ink includes an ionomer.

7. The method of claim 2, wherein a ratio of concentrations by weight of dry extract of said binder and of said catalyst of said anodic electrocatalytic ink is less than or equal to 30%.

8. The method of claim 1, wherein said cathodic electrocatalytic ink includes a carbonaceous material.

9. The method of claim 1, wherein said cathodic electrocatalytic ink comprises platinum.

10. The method of claim 1, wherein assembling said membrane with said first gas diffusion electrode comprises hot pressing.

11. The method of claim 10, wherein hot pressing comprises hot pressing at a temperature of greater than or equal to 120° C., with a pressure greater than or equal to 1 MPa, for a duration greater than three minutes.

12. The method of claim 1, wherein said supplied first and second gas diffusion layers each have a rigidity of between two and forty units on the Taber rigidity scale.

13. The method of claim 1, wherein securing said first gas diffusion layer comprises causing adhesion of said deposited cathodic electrocatalytic ink with said first face of said proton-exchange membrane.

14. The method of claim 1, wherein securing said second gas diffusion layer comprises causing adhesion of said deposited anodic electrocatalytic ink with said first face of said second gas diffusion layer.
